(19) United States
(12) Patent Application Publication
(10) Pub. No.: US 2017/0165618 A1
(43) Pub. Date: Jun. 15, 2017

(54) Method and Apparatus for Aerating Wine and Spirits

(71) Applicant: Georgeann M. Johansson, Arvada, CO (US)

(72) Inventor: Georgeann M. Johansson, Arvada, CO (US)

(73) Assignee: Product Innovations, LLC, Arvada, CO (US)

(21) Appl. No.: 14/967,333

(22) Filed: Dec. 13, 2015

(51) Int. Cl. B01F 3/04; B01F 15/00; B01F 13/00; B01F 7/26; B01F 7/22

(52) U.S. Cl. CPC B01F 3/04794; B01F 7/26; B01F 7/22; B01F 13/002; B01F 15/00519; B01F 15/00538; B01F 2215/0072; B01F 2015/00603

(57) ABSTRACT

A method and apparatus for aerating wine or spirits to reduce the astringency, or bitterness of wine or spirits. Astringency is often a result of tannins in wine or spirits, particularly noticeable in full bodied red wines. Aeration causes oxygen to dissolve in wine or spirits where it will oxidize tannin compounds, thereby reducing the astringent flavor. The method employs an apparatus wherein a hand held unit having a battery, switch or button, electrical wiring and electric motor cause rotation of a drive-shaft and aeration head. The aeration head is immersed in wine or spirits, the switch activated causing rotation of the aeration head creating a plurality of fine air bubbles resulting in large wine or spirit to air surface area simultaneous with stirring to ensure uniform oxygenation and aeration of wine or spirits throughout the container. The process may be extended until the desired reduction in astringency is achieved.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### CROSS-REFERENCE TO RELATED APPLICATIONS

N/A

### FIELD OF THE INVENTION

This invention relates to the method and apparatus for wine and spirits aeration as may be found in current U.S. classification 99/277.2.

### STATEMENT REGARDING FEDERALLY FUNDED RESEARCH

This invention was not made under contract with an agency of the US Government, nor by any agency of the US Government.

### BACKGROUND OF THE INVENTION

Aeration of wine and spirits is a common technique for improving the flavor of wine and spirits largely due to the oxidation of tannins. Tannins are present in wine and spirits, particularly full bodied, red wines that have been bottled within a few years of consumption. Tannins make the flavor of wine and spirits more astringent or bitter. Tannins slowly break down in the anaerobic environment within unopened wine and spirits bottles as years pass, but the process is accelerated to seconds in an aerobic environment. Dissolved oxygen quickly reacts with tannins, effectively accelerating the aging of wine and spirits. There is an optimum range of time as over several hours of exposure to oxygen, the flavor of wine will turn negatively.

There are many methods of aerating wine and spirits. The most basic method is to open the wine or spirits bottle and let it sit for 30 minutes to hours prior to serving. However, a wine or spirits bottle has such a narrow profile that it provides very little wine or spirit to air surface area to dissolve oxygen from air into the wine or spirits to oxidize tannins. Moreover, with no stirring or agitation, only the layer of wine or spirits near the air surface is oxygenated. Thus, the process is often too lengthy for practical use.

A somewhat improved method of aerating wine and spirits is decanting. A decanter is an open container with an enlarged lower section designed such that its widest area occurs at the 750 mL volume level, the typical volume of a bottle of wine or spirit. A decanter thus provides enlarged wine or spirit to air surface area for enhanced aeration of wine or spirits. Disadvantages of this method include the volume of wine or spirits aerated per batch is fixed at 750 mL, while wine drinking continues to migrate away from bottles to single serving since the invention of bag-in-box packaging (see U.S. Pat. No. 3,474,933, Oct. 28, 1969, Malpas, et al.). Other disadvantages of decanting include the time required for effective aeration is lengthy at 15 minutes to hours, decanters can be fragile, large to store and carry, are thus not easily portable if traveling and require cleaning after use, especially considering that sediment from wine will settle in the bottom of the decanter.

U.S. Pat. No. 8,807,358 (Aug. 19, 2014, Joseph Devoy, et al.) teaches an aerating bottle spout. The spout is affixed to the wine bottle after opening. While pouring, wine passes through the spout as air displaces its volume in the wine bottle, momentarily passing one another. The actual time of this operation is quite short and the volume of air to which the wine is exposed is the same as the volume of wine in the bottle due to direct displacement. As a result, no appreciable effect is realized by this or other aerating spouts. Aerating spouts are only applicable to wine packaged in bottles.

U.S. Pat. No. 8,925,443 (Jan. 6, 2015, Dhruv Agarwal, et al.) and U.S. Pat. No. 7,614,614 (Nov. 10, 2009, Sabadicci et al.) each teach a wine aerator apparatus wherein the flow of wine through a Venturi tube creates a slight vacuum consistent with Bernoulli's principle. Passages allow air to flow into the slight vacuum and intermix with the wine. In practicality, the change in velocity of flowing wine over the short height difference is ineffective to develop a strong vacuum induced air flow for thorough aeration of wine. Additionally, the small air passageways are difficult to clean and thus commonly plug.

U.S. Pat. Nos. 8,567,305, 8,561,970, 6,508,163, 5,595,104, 4,785,724 and 4,494,452 and US Patent Application numbers 20140263461 and 20100058933 all teach to various methods of aerating wine while still in the wine bottle, using an immersed bubbler. None offer thorough aeration to the extent required to make a noticeable reduction in astringency due to oxidation of tannins since only a central column within the wine is exposed to a few large bubbles without much wine to air surface area. These devices are only applicable to wine packaged in bottles. If these devices are inserted in a freshly opened bottle of wine, displacement from the device and bubbles will cause overflow of the wine from the bottle.

U.S. Pat. No. 7,543,978 (Jun. 9, 2009, Lisa W. Clement) teaches a wine stopper with a traditional hand operated whisk attached to the top. It lacks motive means, energy supply, aeration head and drive-shaft. Substantial time and effort would be required to operate the whisk to the degree required for effective wine aeration. If the user was traveling, the device would be difficult to clean and would be somewhat awkward to carry, especially when dripping with wine from recent use.

One recent discovery was that an entire bottle of wine could be poured into a food processor and mixed for a few seconds (see http://www.bloomberg.com/bw/magazine/how-to-decant-wine-with-a-blender-09222011.html). The inventors tested the process and found it is quite effective. The short time of operation is counteracted by the thorough aeration inside of the food processor. Disadvantages of this process are food processors are large to store, treat large volumes of wine incompatible with current trends toward single serving from bag-in-box packages, are not easily portable if traveling, are not self-powered, and require thorough cleaning after use.

US Patent Application Number 20050029685 (Feb. 10, 2005, Hang Zhao) teaches a long cowl from an air inlet port to an air outlet port, an agitator, and a rotational drive-shaft. For motive means, it mentions only a separate “hand held motor” without further explanation of how it would work. It is specifically designed for “temporary connection” to a motor housing with a motor to be coupled to the drive-shaft. It makes no mention of wine or spirits. Note that the wide cowling will prevent it from actually entering most wine glasses. Since it teaches toward the frothing of milk, it cannot teach toward aeration of wine or spirits.

U.S. Pat. No. 6,558,035 (May 6, 2003, Gary Arron Lane) teaches an electric mixing whisk, specifically directed toward “ . . . frothing milk for use in specialty coffees . . . ”, and thus cannot teach to a method of aerating wine or spirits.

It is well established doctrine that a new use may be made for an old device, in fact, Congress codified this well established doctrine in 1952 as 35 USC Sec. 100 (b): “The term “process” means process, art or method, and includes a new use of a known process, machine, manufacture, composition of matter, or material.” It is worth noting that nothing in recent court cases regarding “abstract ideas” can overturn this statutory authority.

IUPAC Compendium of Chemical Terminology (see: http://goldbook.iupac.org/) defines “froth” (used interchangeably with foam) and “aeration” as follows:
Foam: “A dispersion in which a large proportion of gas by volume in the form of gas bubbles, is dispersed in a liquid, solid or gel. The diameter of the bubbles is usually larger than 1 micron, but the thickness of the lamellae between the bubbles is often in the usual colloidal size range. The term froth has been used interchangeably with foam. In particular cases froth may be distinguished from foam by the fact that the former is stabilized by solid particles (as in froth flotation q.v.) and the latter by soluble substances.”
Aeration: The process by which a volume filled with a liquid becomes permeated with air or another gas; aeration is often accomplished by spraying the liquid into the air, bubbling air through a liquid or agitating the liquid to promote surface absorption of air.”
   Thus, frothing and aeration are distinctly different processes.

It would be preferable to provide a self-powered, hand-held wine and spirits aeration apparatus and method of use, substantially similar to an electric mixing whisk directed toward the process of frothing milk. Such an apparatus would allow wine and spirits to be aerated in a single serving size container, with intense aeration for a short duration of seconds, offering portability and easy cleaning by simply centripetally spinning off excess wine or spirits.

### BRIEF SUMMARY OF THE INVENTION

The present invention teaches a method of aerating wine and spirits, and thus reducing the astringent flavors, using a hand held unit having an electric motor, battery, switch or button and supporting electrical circuitry to cause the rotation of a drive-shaft affixed to an aeration head that is immersed in wine or spirits in a single serving container. When activated, the aeration head creates a plurality of fine air bubbles resulting in large wine or spirit to air surface area simultaneous with stirring to ensure uniform aeration of wine and spirits throughout the container. As bubbles rise to the surface and collapse, the process may be extended introducing fresh air bubbles until the desired reduction in tannin derived astringency is achieved to the user's personal discretion, usually in a matter of seconds.

### BRIEF DESCRIPTION OF THE DRAWINGS

FIG. 1A depicts a front view of the assembled wine and spirits aerator, with a first type of aeration head.

FIG. 1B depicts a cross-sectional view of the assembled wine and spirits aerator, with a first type of aeration head.

FIG. 2 depicts a front view of a second embodiment of the aeration head.

FIG. 3 depicts an isometric view of a third embodiment of the aeration head.

FIG. 4 depicts an isometric view of a fourth embodiment of the aeration head.

FIG. 5 sets forth a process flow chart of the method of aerating wine and spirits using this invention.

FIG. 6 depicts the aerator with the aeration head immersed in wine or spirits providing aeration.

### INDEX OF REFERENCE NUMERALS

Wine and Spirits Aerator Assembly 100
Housing 102
Electrical/switch or Button 104
Drive-shaft 106
Aeration Head, Single Whisk, First Embodiment 108
Battery Support 110
Battery 112
Electric Motor 114
Rotating Assembly, Second Embodiment 200
Drive-Shaft 202
Aeration Head, Second Embodiment, Double Whisk 204
Rotating Assembly, Third Embodiment 300
Drive-Shaft 302
Aeration Head, Third Embodiment, Turbine 304
Rotating Assembly, Fourth Embodiment 400
Drive-Shaft 402
Aeration Head, Fourth Embodiment, Impeller 404
Process Flow Diagram 500
Start: Provide aerator 502
Unit Operation: Immerse aeration head in wine or spirits 504
Unit Operation: Actuate rotation of aeration head 506
Unit Operation: Remove aeration head from wine or spirits 508
Decision by taste test: Is aeration achieved? 510
End: Process complete 512
Aeration device with the aeration head immersed in wine or spirits 600
Aeration device 602
Wine or spirits in a single serving container undergoing aeration 604

### DETAILED DESCRIPTION OF THE INVENTION

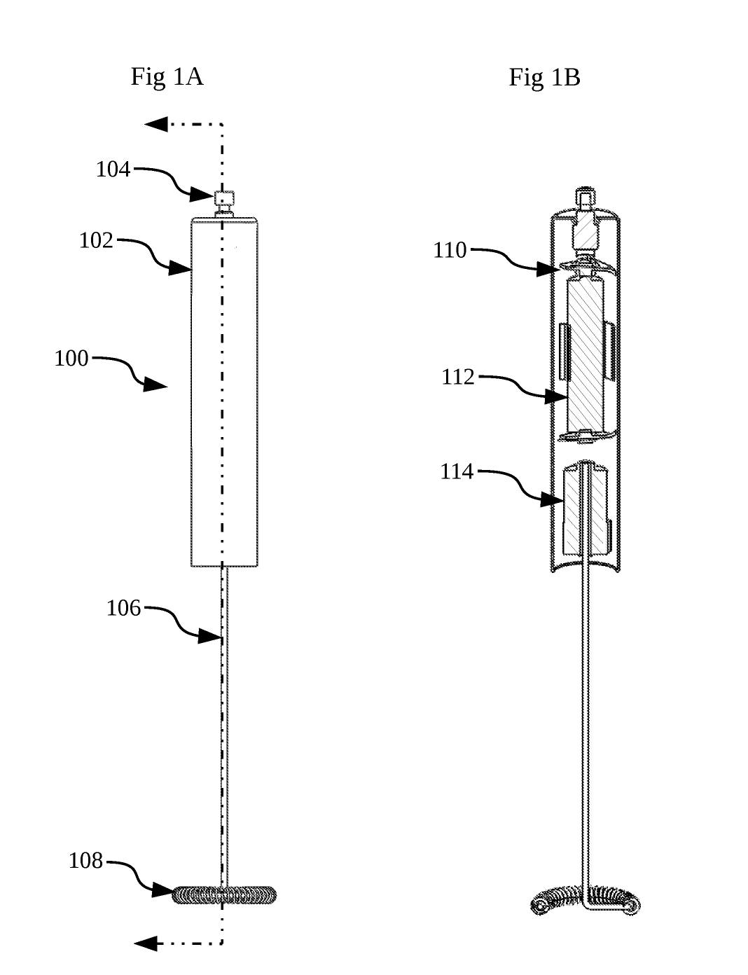

Referring now to FIG. 1, there is illustrated a front view with accompanying cross-section of the first embodiment of the wine and spirits aeration device 100 with the first type of aeration head 108. The aeration device consists of a housing 102 which provides mechanical support to components of the aeration device including the battery support 110. The battery support provides mechanical support and electrical contacts to the battery 112. Wiring carries the electrical current from the battery support electrical contacts to the electrical contacts of the electrical switch 104 also affixed to the housing. The switch may be a momentary, normally open or maintained type. The switch allows the user to control when and for what duration the aerator will operate. When the switch is closed, electrical current is allowed to flow through wiring to the motor 114. The motor is also supported by the housing and is affixed to a drive-shaft. Thus, the motor rotates causing the drive-shaft to rotate. The drive-shaft projects from the housing and has affixed to the projected end the aeration head 108. The rotation of the drive-shaft causes rotation of the affixed aeration head 108. The aeration head in this embodiment is a helix that wraps to form a loop around the axis of rotation. As the helix is rotated by the drive shaft, the helix creates a vortex and draws air in the wine or spirits thereby aerating the wine or spirits in which the aeration device is immersed.

The housing 102 may be constructed from any number of structural materials including metals and plastics. The battery support may also be constructed from any number of structural materials including metals and plastics provided there is electrical isolation between the electrical contacts, sufficient restraining force to support a standard battery or batteries, and maintain sufficient pressure on the electrical contacts to sustain electrical current at low voltage (<20V). Wiring may be of any electrically conductive material such as copper or aluminum, and is typically coated with an electrically insulating material such as polyvinyl chloride (PVC). The wiring may be crimped, soldered or any other means of creating electrical contact to the battery support, switch and motor. The switch is a subassembly of components that create an electrically conductive path when closed and are otherwise electrically open. The switch may be of the momentary type wherein constant pressure is required to remain in the closed position, or of the maintained type wherein a single actuation closes the switch and another actuation is required to open the switch. The motor is a direct-current, low voltage type appropriate for operation by standard batteries (<20V). The drive shaft and helical aeration head may be plated steel, stainless steel, other metal or plastic that are safe for food contact and durable.

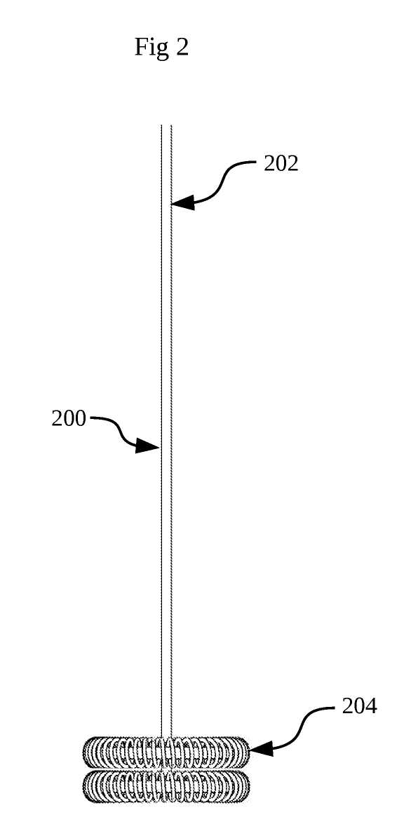

Referring now to FIG. 2, there is illustrated a second embodiment of the invention wherein the rotating assembly 200 is comprised of a drive shaft 202 causes rotation of an aeration head 204 that is comprised of a double helix.

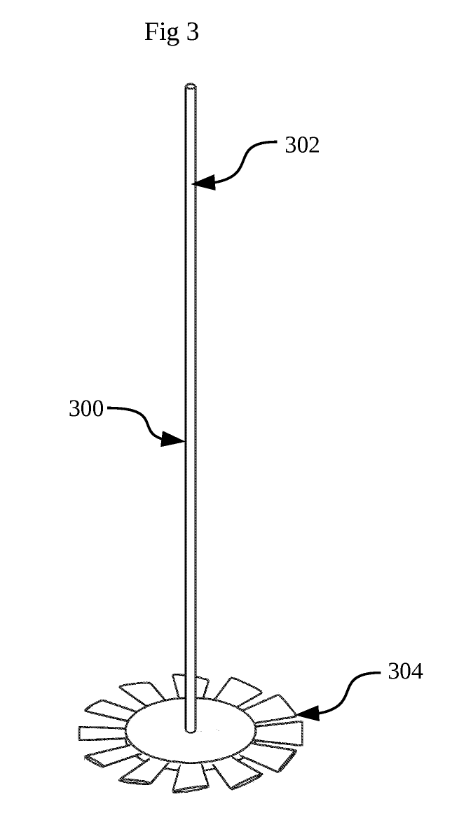

Referring now to FIG. 3, there is illustrated a third embodiment of the invention wherein the rotating assembly 300 is comprised of a drive shaft 302 causes rotation of an aeration head 304 that is comprised of a turbine wheel.

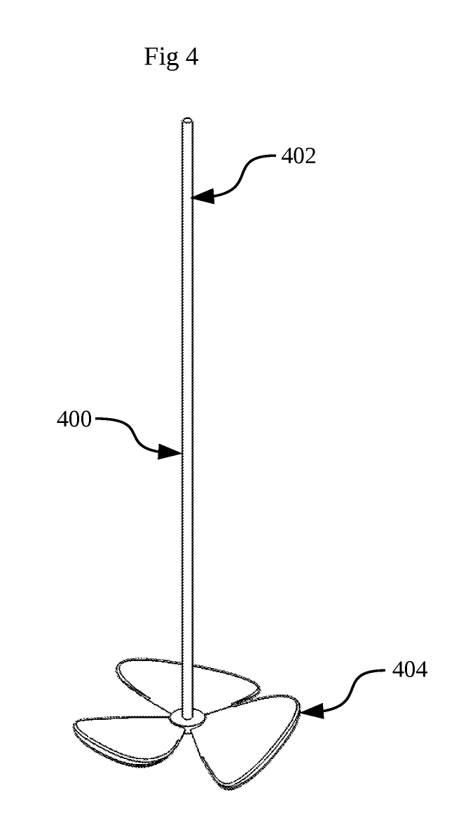

Referring now to FIG. 4, there is illustrated a fourth embodiment of the invention wherein the rotating assembly 400 is comprised of a drive shaft 402 causes rotation of an aeration head 404 that is comprised of a impeller.

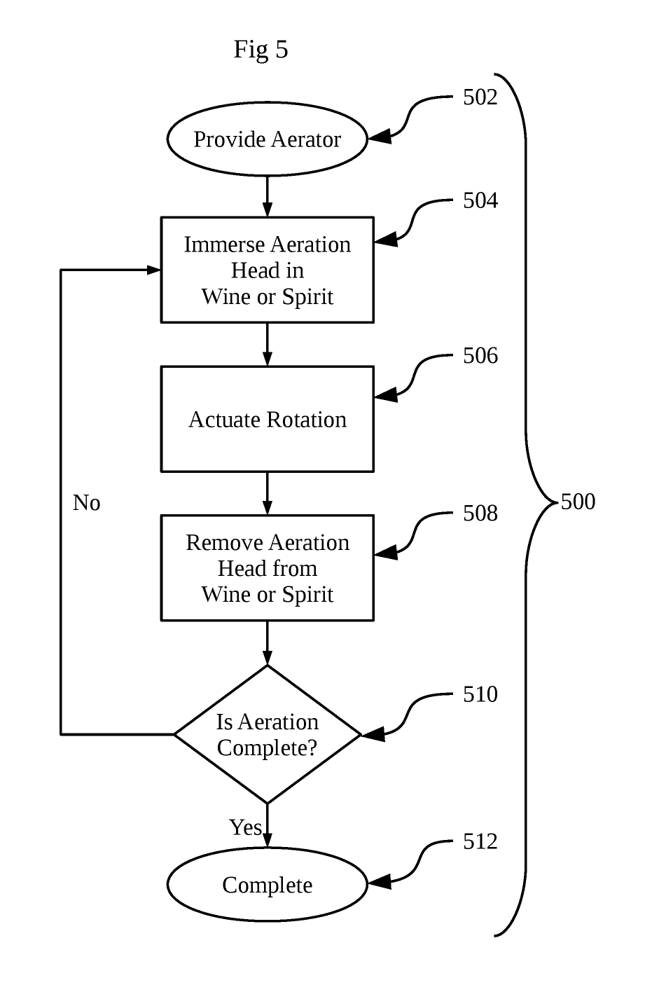

Referring now to FIG. 5, the is illustrated a process flow diagram 500 of the method of aerating wine or spirits with the present invention.
Process step 502 is simply holding the aeration apparatus in one's hand.
Process step 504 is immersing the aeration head in wine or spirits in a container such as a wine glass.
Process step 506 is pressing the button or switch to apply electrical power to the motor thereby causing rotation of the shaft and the aeration head.
Process step 508 removes the apparatus from the container.
Process step 510 is a taste test to decide whether the wine or spirits is sufficiently aerated and is ready to enjoy or whether more aeration is required by returning to step 502 until the wine or spirits is sufficiently aerated.
Process step 512 terminates the process.

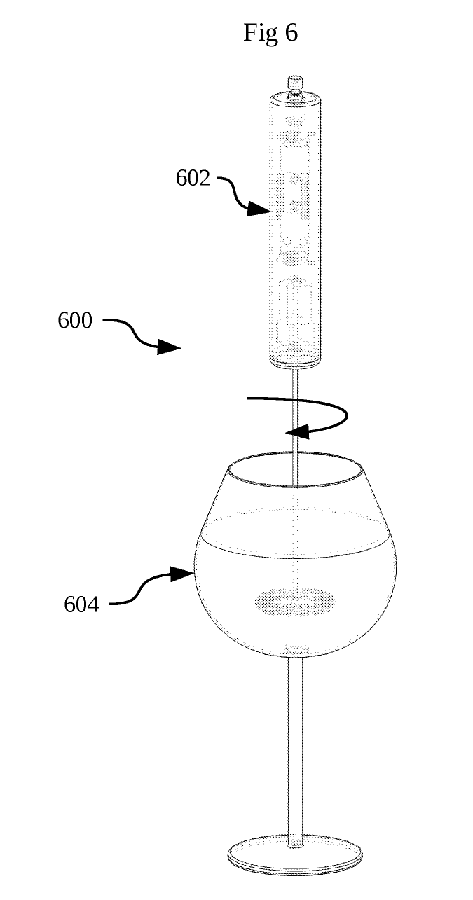

Referring now to FIG. 6, there is illustrated the application 600 of the invention 602 with aeration head immersed in a single serving container of wine or spirits 604 providing rotation through the drive-shaft to the aeration head thereby aerating the wine or spirits.

Note that these methods are not mutually exclusive and in embodiments may be used together. Throughout this application, various publications, patents, and/or patent applications are referenced in order to more fully describe the state of the art to which this invention pertains. The disclosures of these publications, patents, and/or patent applications are herein incorporated by reference in their entireties, and for the subject matter for which they are specifically referenced in the same or a prior sentence, to the same extent as if each independent publication, patent, and/or patent application was specifically and individually indicated to be incorporated by reference.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

What is claimed is:

1. A hand-held device for aerating wine and spirits in a container such as a wine glass, the device comprising:
a body having an interior and an exterior;
the body having an electric motor and battery in the interior;
the body with electric motor and battery in the interior dimensioned and configured to be held in the palm of such hand;
a shaft connected to and rotated by the electric motor, the shaft extending from one end of the electric motor, extending out of the body;
the shaft dimensioned and configured to extend a distance into such container to reach such wine or spirits;
the shaft carrying thereupon an aeration head dimensioned and configured to be smaller than such container, whereby they may be extended into such container on such shaft and rotated to cause aeration of the wine or spirits;

2. The hand-held device for aerating wine and spirits of claim 1, wherein:
the shaft has a length of 2″ (50 mm) to 10″ (250 mm).

3. The hand-held device for aerating wine and spirits of claim 1, wherein:
the aeration head further comprises a wire helix.

4. The hand-held device for aerating wine and spirits of claim 3, wherein the wire helix completes more than one complete revolution about the shaft.

5. The hand-held device for aerating wine and spirits of claim 1, wherein:
the aeration head further comprises: a plurality of angled blades.

6. The hand-held device for aerating wine and spirits of claim 1, further comprising:
an activation switch having two positions, a first position in which the electric motor is not activated and a second position in which the electric motor is activated.

7. A method of aerating wine and spirits in a container, the method comprising the steps of:
providing a hand-held electric wine and spirits aerator dimensioned and configured to be held in the palm of such hand, having an elongated rotating shaft dimensioned and configured to extend into such container to such wine or spirits, and further having an aeration head on such shaft;
extending such shaft into such container until such aeration head reaches such wine or spirits;
activating the electric wine and spirits aerator to rotate the shaft, thereby rotating the aeration head on such shaft, thereby aerating such wine or spirits, whereby such astringent flavors are reduced.
